(19) United States
(12) Patent Application Publication
(10) Pub. No.: US 2007/0236145 A1
(43) Pub. Date: Oct. 11, 2007

(54) PLASMA DISPLAY PANEL AND PLASMA DISPLAY APPARATUS INCLUDING THE SAME

(76) Inventors: Kyoung-Doo Kang, Suwon-si (KR); Won-Ju Yi, Suwon-si (KR); Ho-Young Ahn, Suwon-si (KR); Dong-Young Lee, Suwon-si (KR); Soo-Ho Park, Suwon-si (KR); Seok-Gyun Woo, Suwon-si (KR); Jae-Ik Kwon, Suwon-si (KR)

Correspondence Address: CHRISTIE, PARKER & HALE, LLP, PO BOX 7068, PASADENA, CA, 91109-7068, US

(21) Appl. No.: 11/734,232

(22) Filed: Apr. 11, 2007

(30) Foreign Application Priority Data
Apr. 11, 2006 (KR) 10-2006-0032660
Apr. 14, 2006 (KR) 10-2006-0034170

(51) Int. Cl. H01J 17/49

(52) U.S. Cl. 313/582

(57) ABSTRACT

A plasma display panel (PDP) that is light in weight and low in manufacturing costs and a plasma display apparatus including the PDP. The PDP includes a substrate; a barrier rib structure disposed on the substrate to define a plurality of discharge cells; a sealing layer configured together with the substrate to seal the discharge cells and being formed of a substantially identical material as the barrier rib structure; a plurality of discharge electrode pairs extending along respective lines of the discharge cells to generate discharge in the discharge cells; and a plurality of phosphor layers disposed in the discharge cells.

### CROSS-REFERENCE TO RELATED PATENT APPLICATION

This application claims priority to and the benefit of Korean Patent Application Nos. 10-2006-0032660, filed on Apr. 11, 2006, in the Korean Intellectual Property Office, and 10-2006-0034170, filed on Apr. 14, 2006, in the Korean Intellectual Property Office, the entire contents of which are incorporated herein by reference.

### BACKGROUND OF THE INVENTION

1. Field of the Invention

The present invention relates to a plasma display panel and a plasma display apparatus including the same.

2. Description of the Related Art

Plasma display panels (PDPs) have recently received considerable attention as a replacement for conventional cathode ray tube display devices. PDPs are apparatuses that display images using visible light emitted though a process of exciting a phosphor material formed in a pattern (that may be predetermined) with ultraviolet rays generated from a discharge of a discharge gas filled between two substrates on which a plurality of electrodes are formed.

FIG. 1 is an exploded perspective view illustrating a conventional PDP 100. The PDP 100 includes a front substrate 101, a plurality of sustain electrodes 106 and 107 located on (or directly on) the front substrate 101, a front dielectric layer 109 covering the sustain electrodes 106 and 107, a protective layer 111 covering the front dielectric layer 109, a rear substrate 115 facing the front substrate 101, a plurality of address electrodes 117 disposed in parallel with each other on (or directly on) the rear substrate 115, a rear dielectric layer 113 covering the address electrodes 117, a plurality of barrier ribs 114 formed on the rear dielectric layer 113, and a plurality of phosphor layers 110 formed on an upper surface of the rear dielectric layer 113 and on lateral surfaces of the barrier ribs 114.

Here, in the conventional PDP 100, the front substrate 101 and the rear substrate 115 are formed of glass having a thickness of a few mm. The glass substrate is heavy and expensive. However, since the sustain electrodes 106 and 107 and the address electrodes 117 are respectively formed directly on the front substrate 101 and the rear substrate 115, the front substrate 101 and the rear substrate 115 must be formed using glass despite the heavy weight and high cost.

### SUMMARY OF THE INVENTION

An aspect of an embodiment of the present invention is directed to a plasma display panel that can be light in weight and/or be produced with low costs.

An aspect of an embodiment of the present invention is directed to a plasma display panel that can be manufactured by a simple manufacturing process.

An aspect of an embodiment of the present invention is directed to a plasma display apparatus including the plasma display panel.

According to an embodiment of the present invention, there is provided a plasma display panel including: a substrate; a barrier rib structure disposed on the substrate to define a plurality of discharge cells; a sealing layer configured together with the substrate to seal the discharge cells and being formed of a substantially identical material as the barrier rib structure; a plurality of discharge electrode pairs extending along respective lines of the discharge cells to generate discharge in the discharge cells; and a plurality of phosphor layers disposed in the discharge cells.

According to another embodiment of the present invention, there is provided a plasma display apparatus including: a substrate; a barrier rib structure disposed on the substrate to define a plurality of discharge cells; a sealing layer configured together with the substrate to seal the discharge cells and being formed of substantially identical material as the barrier rib structure; a plurality of discharge electrode pairs extending along respective lines of the discharge cells to generate discharge in the discharge cells; a plurality of phosphor layers disposed in the discharge cells; and a chassis disposed on a side of the sealing layer to support the substrate.

According to another embodiment of the present invention, there is provided a plasma display panel including: a single substrate; a barrier rib structure disposed on the single substrate to define a plurality of discharge cells; a sealing layer configured together with the single substrate to seal the discharge cells and being formed of a substantially identical material as the barrier rib structure; an electrode pair extending along at least one line of the discharge cells to generate discharge in the discharge cells; and a plurality of phosphor layers disposed in the discharge cells.

The discharge electrode pairs may be buried in the sealing layer.

The sealing layer and the barrier rib structure may be formed of a dielectric material selected from the group consisting of SiO₂, Al₂O₃, TiO₂, BaO, CaO, B₂O₃, ZnO, R₂O PbO, Bi₂O₃, Ca—B—SiO₂, SnO, and combinations thereof.

The sealing layer and the barrier rib structure may be formed as one unit.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an exploded perspective view illustrating a conventional plasma display panel.

FIG. 2 is a partial exploded perspective view illustrating a plasma display panel according to an embodiment of the present invention.

FIG. 3 is a cross-sectional view of the plasma display panel of FIG. 2 taken along a line III-III of FIG. 2 according to an embodiment of the present invention.

FIG. 4 is a schematic perspective view of discharge cells and first and second discharge electrodes of the plasma display panel of FIG. 2 according to an embodiment of the present invention.

FIG. 5 is a cross-sectional view illustrating a plasma display panel having a three-electrode structure according to an embodiment of the present invention.

FIG. 6 is a schematic perspective view of discharge cells and first and second discharge electrodes of the plasma display panel of FIG. 5 according to an embodiment of the present invention.

FIG. 7 is a cross-sectional view illustrating a method of manufacturing the plasma display panel of FIG. 2 according to an embodiment of the present invention.

FIG. 8 is a partial exploded perspective view illustrating a plasma display panel according to another embodiment of the present invention.

FIG. 9 is a cross-sectional view of the plasma display panel of FIG. 8 taken along a line IX-IX of FIG. 8 according to an embodiment of the present invention.

FIG. 10 is a cross-sectional view illustrating a plasma display apparatus according to another embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Also, in the context of the present application, when an element is referred to as being “on” another element, it can be directly on the another element or be indirectly on the another element with one or more intervening elements interposed therebetween. Hereinafter, like reference numerals refer to like elements.

### First Embodiment

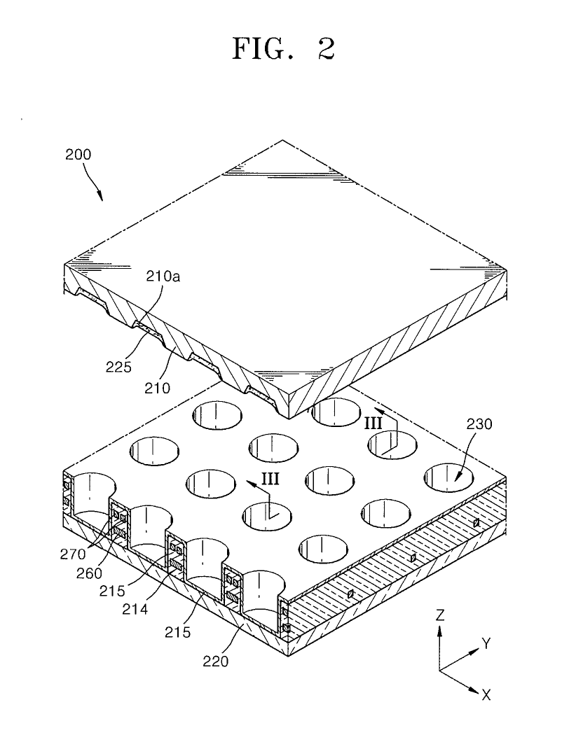

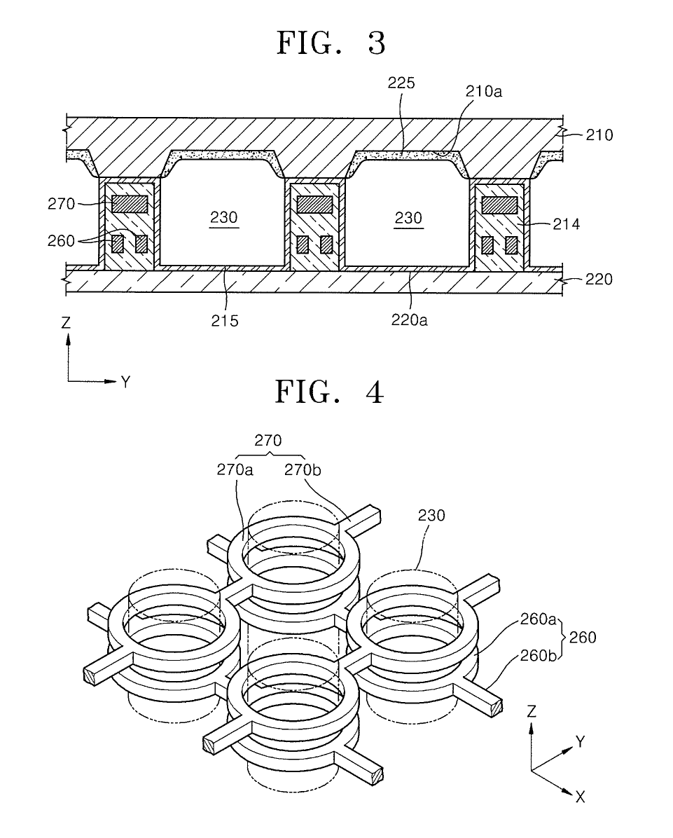

FIG. 2 is a partial exploded perspective view illustrating a plasma display panel (PDP) 200 according to an embodiment of the present invention. FIG. 3 is a cross-sectional view of the plasma display panel of FIG. 2 taken along a line III-III of FIG. 2, and FIG. 4 is a schematic perspective view of discharge cells 230 and first and second discharge electrodes 260 and 270 of the plasma display panel of FIG. 2.

The PDP 200 includes a substrate 210, a sealing layer 220, a barrier rib structure 214, a plurality of first discharge electrodes 260, a plurality of second discharge electrodes 270, a plurality of phosphor layers 225, and protective layer(s) 215.

In one embodiment, the substrate 210 is formed of a material containing glass as a main component and having a relatively high optical transmittance. The substrate 210 can be colored to increase contrast (e.g., to increase bright room contrast) by reducing reflective brightness.

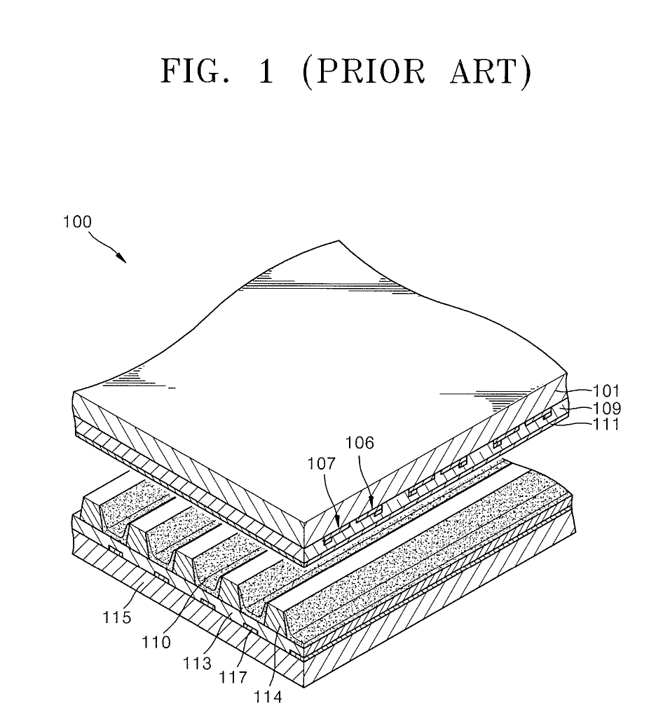

In the embodiment of FIGS. 2, 3 and/or 4, visible light generated by the discharge cells 230 can be emitted to the outside through the substrate 210. The transmittance of the visible light is significantly increased since the sustain electrodes 106 and 107, the front dielectric layer 109, and the protective layer 111 formed on the front substrate 101 of the PDP 100 of FIG. 1 are not formed on the substrate 210 through which the visible light is transmitted. Accordingly, when an image is displayed on the PDP 200 with a brightness of a certain (or set or conventional) level, the first and second discharge electrodes 260 and 270 of the embodiment of FIGS. 2, 3, and/or 4 can be driven with a voltage lower than that of the embodiment of FIG. 1.

Referring to FIGS. 2 and 3, the barrier rib structure 214 is formed on the substrate 210 to define the discharge cells 230 and to reduce (or prevent) electrical and optical cross-talk between adjacent discharge cells 230. In the present embodiment, the barrier rib structure 214 is configured to define discharge cells 230 having a circular horizontal cross-section, but the present invention is not limited to such an arrangement. That is, the barrier rib structure 214 can be configured to define discharge cells 230 having horizontal cross-sections of various suitable shapes (e.g., a polygonal shape such as a triangle, a rectangle, or a pentagon; an oval; etc.) as long as the barrier rib structure 214 can define the plurality of discharge cells 230. In addition, the barrier rib structure 214 can be configured to define discharge cells 230 having a delta or waffle shape.

The sealing layer 220 is formed on a lower surface of the barrier rib structure 214 to seal the discharge cells 230. The sealing layer 220 may be formed to tightly contact the lower surface of the barrier rib structure 214. The sealing layer 220 can be formed of the same material (or substantially the same material) as the barrier rib structure 214, for example, can be formed of at least one dielectric material selected from the group consisting of SiO₂, Al₂O₃, TiO₂, BaO, CaO, B₂O₃, ZnO, R₂O PbO, Bi₂O₃, Ca—B—SiO₂, SnO, and combinations thereof. The sealing layer 220 may be formed with the barrier rib structure 214 as a single unit, which will be described later in more detail.

Referring also to FIG. 4, the first and second discharge electrodes 260 and 270 are formed in the barrier rib structure 214. The first and second discharge electrodes 260 and 270 are form in pairs (e.g., in opposing pairs) to generate discharge in the discharge cells 230. Each of the first discharge electrodes 260 extends to surround the discharge cells 230 disposed in a first direction (e.g., an X direction). The first discharge electrodes 260 include first loop units 260a that surround the discharge cells 230 (e.g., each of the first loop units surrounds a corresponding one of the discharge cells 230) and first loop connection units 260b that connect the first loop units 260a. In the present embodiment, each of the first loop units 260a has a circular (or annular) shape, but the present invention is not limited thereto. That is, the first loop unit 260a can have various suitable loop shapes including a rectangular shape. In one embodiment, the first loop unit 260a has a shape substantially the same as the horizontal cross-section of one or more of the discharge cells 230. In one embodiment, instead of being a closed loop, the first loop unit 260a can also be partly opened.

Each of the second discharge electrodes 270 extends to surround the discharge cells 230 disposed in a second direction (e.g., a Y direction) that crosses the first direction (e.g., the X direction), and is formed in the barrier rib structure 214 to be separated from the first discharge electrodes 260 in (or along) a third direction (e.g., in or along a Z direction perpendicular to the substrate 210). The second discharge electrodes 270 are formed closer to the substrate 210 than the first discharge electrodes 260, but the present invention is not limited to such an arrangement. The second discharge electrodes 270 include second loop units 270a that surround the discharge cells 230 (e.g., each of the second loop units surrounds a corresponding one of the discharge cells 230) and second loop connection units 270b that connect the second loop units 270a. In the present embodiment, each of the second loop units 270a has a circular (or an annular) shape, but the present invention is not limited thereto. That is, the second loop unit 270a can have various suitable shapes including a rectangular shape, and, in one embodiment, may have substantially the same shape as the horizontal cross-section of one or more of the discharge cells 230. The second loop unit 270a can also be partly opened.

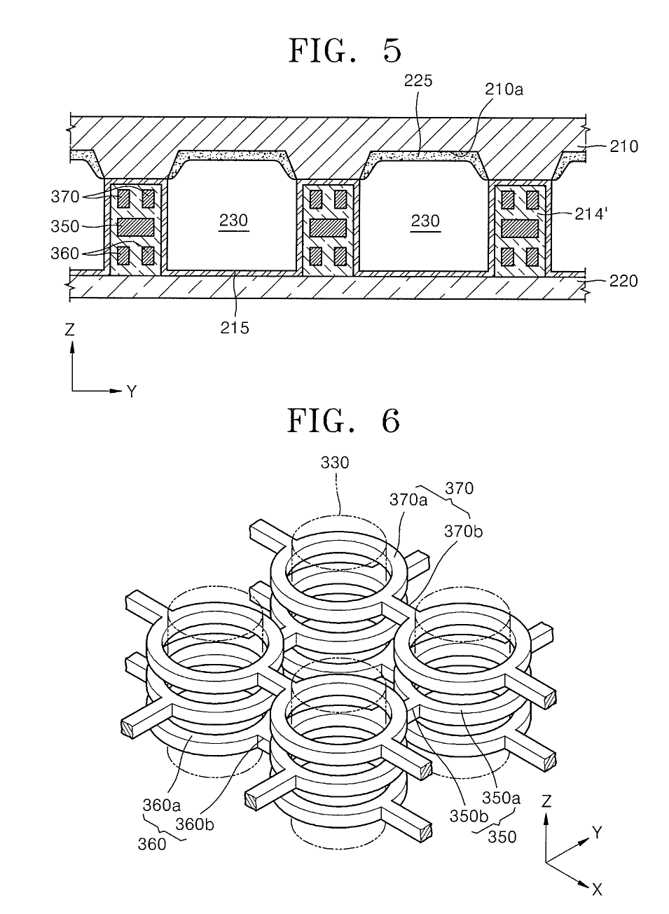

The PDP 200 according to the present embodiment has a two-electrode structure. Accordingly, in one embodiment, the first discharge electrodes 260 act as scanning electrodes and sustain electrodes, and the second discharge electrodes 270 act as both address electrodes and sustain electrodes. In another embodiment, the second discharge electrodes 270 act as the scanning electrodes and the sustain electrodes, and the first discharge electrodes 260 act as both the address electrodes and the sustain electrodes. However, the present invention is not limited to the two-electrode structure but also can have a three-electrode structure. FIG. 5 is a cross-sectional view illustrating a plasma display panel having a three-electrode structure, and FIG. 6 is a schematic perspective view of discharge cells and first and second discharge electrodes of the plasma display panel of FIG. 5 according to an embodiment of the present invention. In FIGS. 5 and 6, like reference numerals refer to the like elements in FIGS. 2 through 4. Referring to FIGS. 5 and 6, first and second discharge electrodes 360 and 370 are formed in pairs to generate discharge in discharge cells 330, and extend parallel to each other. Each of the first discharge electrodes 360 includes first loop units 360a that surround discharge cells 230 which are disposed in a first direction (e.g., an X direction) and first loop connection units 360b that connect the first loop units 360a. Also, each of the second discharge electrodes 370 includes second loop units 370a that also surround the discharge cells 230 which are disposed in the first direction (e.g., the X direction) and second loop connection units 370b that connect the second loop units 370a. Address electrodes 350 extend in a second direction (e.g., a Y direction) crossing the first direction (e.g., the X direction or the extending direction) of the first discharge electrodes 360 and the second discharge electrodes 370. The address electrodes 350 are spaced a distance (that may be predetermined) apart from the first and second discharge electrodes 360 and 370 in a barrier rib structure 214′ in (or along) a third (or vertical) direction (e.g., a Z direction) to the substrate 210. Each of the address electrodes 350 includes third loop units 350a that surround the discharge cells 230 (e.g., the discharge cell 230 disposed in the second direction) and third loop connection units 350b that connect the third loop units 350a. In the present embodiment, the second discharge electrodes 370, the address electrodes 350, and the first discharge electrodes 360 are sequentially disposed in the barrier rib structure 214′ in a direction perpendicular to the substrate 210 to reduce an address discharge voltage. However, the present invention is not limited to such an arrangement. That is, the address electrodes 350 can be disposed in the barrier rib structure 214′ in a position closest to the substrate 210 or in a position farthest from the substrate 210, or the address electrodes 350 can be formed in the sealing layer 220. The address electrodes 350 are formed to generate an address discharge, which facilitates sustain discharge between the first and second discharge electrodes 360 and 370, and more specifically, to reduce a breakdown voltage for sustain discharge. The address discharge is generated between a scanning electrode and an address electrode. When the address discharge is completed, positive ions are accumulated on the scanning electrode, and electrons are accumulated on the common electrode. Accordingly, the sustain discharge between the scanning electrode and the common electrode can be readily generated. In the present embodiment, the first discharge electrodes 360 act as the scanning electrodes and the second discharge electrodes 370 act as the common electrodes, but the present invention is not limited to such an arrangement.

Referring to FIGS. 2 and 3 again, the first and second discharge electrodes 260 and 270 can be formed of a conductive metal such as copper or aluminum since the first and second discharge electrodes 260 and 270 are disposed in positions that do not directly interrupt the transmittance of visible light. Accordingly, the first and second discharge electrodes 260 and 270 have little voltage drop in (or along) their length direction, thereby enabling stable signal transmission.

Since the first and second discharge electrodes 260 and 270 are buried in the barrier rib structure 214, the barrier rib structure 214 may be formed of a dielectric material that can prevent (or reduce) a direct electrical connection between the adjacent first and second discharge electrodes 260 and 270, can prevent (or reduce) the first and second discharge electrodes 260 and 270 from being damaged due to direct collisions with positive ions or electrons, and/or can accumulate wall charges by inducing charges.

The protective layer(s) 215 are formed on sidewalls and upper surfaces of the barrier rib structure 214 and on the sealing layer 220 exposed by the discharge cells 230. The protective layer(s) 215 prevent (or reduce) the barrier rib structure 214 formed of the dielectric material and the first and second discharge electrodes 260 and 270 from being damaged by sputtering of plasma particles and reduce discharge voltage by emitting secondary electrons. The protective layer(s) 215 can be formed by depositing MgO to thickness (that may be predetermined) on the sidewalls and the upper surfaces of the barrier rib structure 214.

A plurality of first grooves 210a having a depth (that may be predetermined) are formed in the substrate 210 to face the discharge cells 230, respectively. The first grooves 210a are discontinuously formed to face the discharge cells 230, and the phosphor layers 225 are disposed in the first grooves 210a. However, the locations of the phosphor layers 225 are not limited to the first grooves 210a, that is, the phosphor layers 225 can be disposed in various suitable locations. For example, the phosphor layers 225 can be disposed on sidewalls of the barrier rib structure 214, in that case the protective layer(s) 215 may not be formed in the corresponding area. The phosphor layers 225 include a component that emits visible light when ultraviolet rays are received. In one embodiment, the phosphor layers 225 formed in the red light emitting discharge cells 230 include a phosphor material such as Y(V,P)O₄:Eu, the phosphor layers 225 formed in the green light emitting discharge cells 230 include a phosphor material such as Zn₂SiO₄:Mn or YBO₃:Tb, and the phosphor layers 225 formed in the blue light emitting discharge cells 230 include a phosphor material such as BAM:Eu.

A discharge gas such as a mixed gas of Ne and Xe is filled into the discharge cells 230. In the present embodiment, discharge regions can be increased due to increased discharge surfaces. As a result, an amount of plasma increases, thereby enabling relatively low-voltage driving of the PDP 200. In addition, although a high concentration Xe gas is used as a discharge gas, low-voltage driving is possible. Therefore, light emission efficiency of the PDP 200 can be greatly increased. In this way, the difficulty of low-voltage driving in the conventional PDP when a high concentration of Xe gas is used as a discharge gas can be solved.

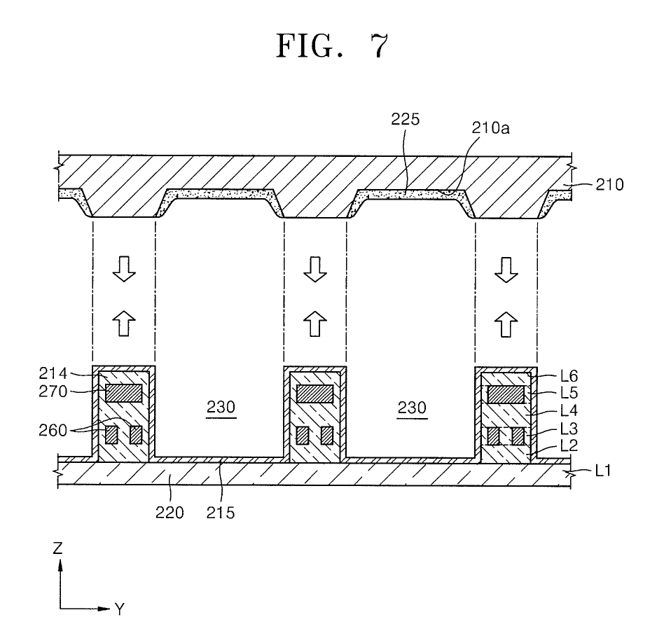

A method of manufacturing the PDP 200 will now be described with reference to FIG. 7.

First, a flat substrate is prepared. The substrate 210 in FIG. 7 is formed by forming the first grooves 210a. The first grooves 210a can be formed by etching and/or sand blasting the substrate 210. Afterwards, the phosphor layers 225 are formed by drying and firing pastes for forming the phosphor layers 225 after coating the pastes in the first grooves 210a.

A barrier rib sheet forming process is performed (e.g., is performed in parallel to the above process for forming the substrate 210). The barrier rib sheet denotes a member in which the barrier rib structure 214, the sealing layer 220, the first and second discharge electrodes 260 and 270, and the protective layer(s) 215 are formed as one unit.

Here, a first dielectric sheet L1 for forming the sealing layer 220 is prepared. Dielectric sheets for forming the barrier rib structure 214 are stacked on the first dielectric sheet L1. More specifically, a second dielectric sheet L2 is prepared and a third dielectric sheet L3 on which the first discharge electrodes 260 are patterned is stacked on the second dielectric sheet L2. A fourth dielectric sheet L4 is stacked on the third dielectric sheet L3, and a fifth dielectric sheet L5 on which the second discharge electrodes 270 are patterned is stacked on the fourth dielectric sheet L4. Afterwards, a sixth dielectric sheet L6 is stacked on the fifth dielectric sheet L5.

After the stacking of the second through sixth dielectric sheets L2, L3, L4, L5, and L6, discharge spaces for forming discharge cells 230 are formed by punching the second through sixth dielectric sheets L2, L3, L4, L5, and L6 in locations where the discharge cells 230 are arranged. After the punching, the second through sixth dielectric sheets L2, L3, L4, L5, and L6 are located on the first dielectric sheet L1. The second through sixth dielectric sheets L2, L3, L4, L5, and L6 and the first dielectric sheet L1 for forming the sealing layer 220 can be formed of a material that is substantially identical, for example, a dielectric material including at least one material selected from the group consisting of SiO₂, Al₂O₃, TiO₂, BaO, CaO, B₂O₃, ZnO, R₂O PbO, Bi₂O₃, Ca—B—SiO₂, SnO, and combinations thereof. Through drying and firing processes, the barrier rib sheet is formed in which the barrier rib structure 214 and the sealing layer 220 are formed as one unit. Afterwards, the protective layer(s) 215 are formed by sputtering MgO. In the above descriptions, each of the first through sixth dielectric sheets L1 L2, L3, L4, L5, and L6 is a single sheet. However, the present invention is not limited thereto, that is, each of the dielectric sheets can have a multi-layered structure.

After the barrier rib sheet is formed, the substrate 210 and the barrier rib sheet are aligned, and are sealed using frit. The manufacture of the PDP 200 is completed by performing a vacuuming process and a discharge gas filling process. After the discharge gas is filled, various subsequent processes including an aging process can be performed.

As described above, in the PDP 200 according to the present embodiment, a manufacturing process is simple because the barrier rib structure 214 and the sealing layer 220 can be formed as one unit, and the similar processes can be performed subsequently.

A method of driving the PDP 200 having the above structure according to an embodiment of the present invention will now be described.

An address discharge is generated between the first and second discharge electrodes 260 and 270, and as a result, discharge cells 230 where sustain discharge will be generated are selected. Afterwards, when an alternating current sustain voltage is applied between the first and second discharge electrodes 260 and 270, a sustain discharge is generated between the first and second discharge electrodes 260 and 270 in the selected discharge cells 230. Ultraviolet rays are generated from the discharge gas excited by the sustain discharge while an energy level of the discharge gas is reduced. The ultraviolet rays excite the phosphor layers 225, and the excited phosphor layers 225 emit visible light while an energy level of the phosphor layers 225 is reduced (e.g., transitions from a higher energy state to a lower energy state). The emitted visible light forms an image.

In the conventional PDP 100, the discharge surface is relatively small because the sustain discharge between the sustain electrodes 106 and 107 occurs in a horizontal direction. However, in the present embodiment, the sustain discharge of the PDP 200 occurs in all surfaces that define the discharge cell 230 and the discharge surface is relatively wide.

Also, in the present embodiment, the sustain discharge occurs in a closed curve along side surfaces of the discharge cells 230 and gradually diffuses into the center of the discharge cells 230. Therefore, the volume of a region where the sustain discharge occurs is increased, and space charges in the discharge cells 230, which are not utilized in the conventional PDP 100, are also involved in light emission, thereby increasing light emission efficiency of the PDP 200. In particular, in the present embodiment, the sustain discharge uniformly occurs on all sides of the discharge cell 230 since the discharge cell 230 has a circular horizontal cross-section.

Since the sustain discharge occurs in a central portion of the discharge cell 230, ion sputtering of charged particles to the phosphor layers 225, which is a problem in the conventional PDP 100, can be reduced or prevented, thereby reducing or preventing the generation of a permanent latent image even if images are displayed on the PDP 200 for a long period of time.

### Second Embodiment

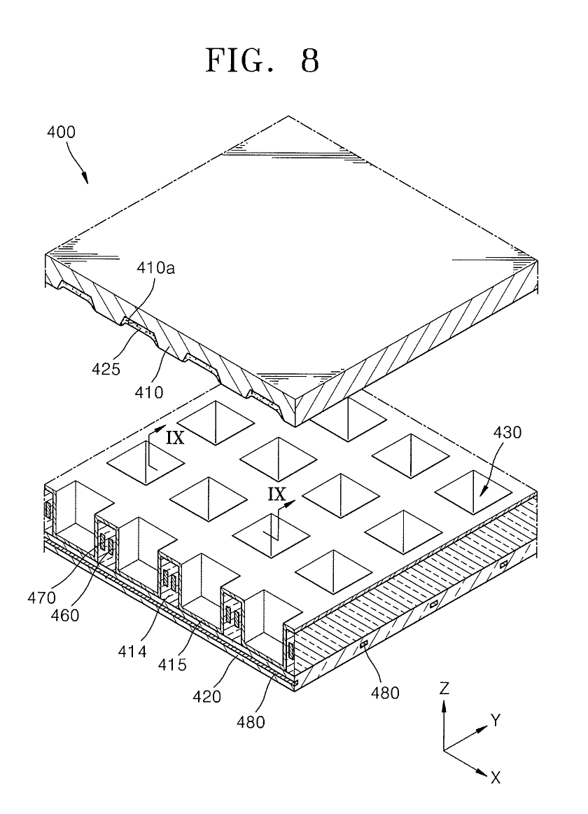

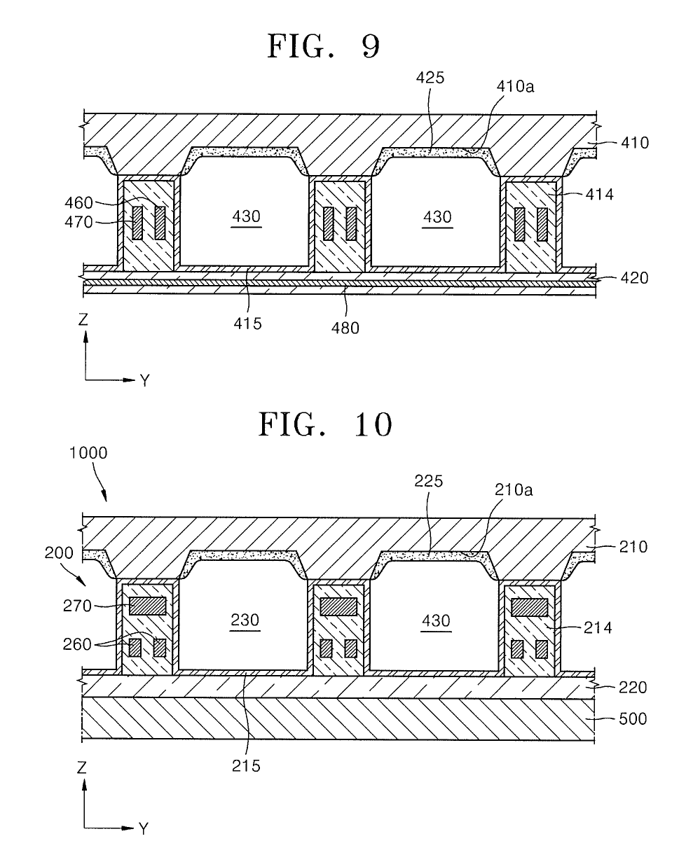

FIG. 8 is a partial exploded perspective view illustrating a plasma display panel (PDP) 400 according to another embodiment of the present invention, and FIG. 9 is a cross-sectional view of the plasma display panel of FIG. 8 taken along a line IX-IX of FIG. 8.

The PDP 400 includes a substrate 410, a sealing layer 420, a barrier rib structure 414, a plurality of first discharge electrodes 460, a plurality of second discharge electrodes 470, a plurality of address electrodes 480, a plurality of phosphor layers 425, and protective layer(s) 415.

A difference between the PDP 400 according to the present embodiment and the PDP 200 is that the first discharge electrodes 460 and the second discharge electrodes 470 have a facing (or opposing) discharge structure. Hereinafter, the present embodiment will be described mainly with respect to the above difference.

The substrate 410 is usually formed of a material containing glass as a main component and having a relatively high optical transmittance. The substrate 410 can be colored to increase bright room contrast by reducing reflective brightness.

Referring to FIGS. 8 and 9, the barrier rib structure 414 is formed on the substrate 410 to define discharge cells 430 and to reduce (or prevent) electrical and optical cross-talk between adjacent discharge cells 430. In the present embodiment, the barrier rib structure 414 is configured to define the discharge cells 430 having a rectangular horizontal cross-section, but the present invention is not limited to such an arrangement.

The sealing layer 420 is formed on lower surfaces of the barrier rib structure 414 to seal the discharge cells 430. The sealing layer 420 may be formed to tightly contact the lower surfaces of the barrier rib structure 414. The sealing layer 420 and the barrier rib structure 414 can be formed of the same material, such as a dielectric material selected from the group consisting of SiO₂, Al₂O₃, TiO₂, BaO, CaO, B₂O₃, ZnO, R₂O PbO, Bi₂O₃, Ca—B—SiO₂, SnO, and combinations thereof. The sealing layer 420 and the barrier rib structure 414 may be formed as one unit for manufacturing convenience.

The first discharge electrodes 460 and the second discharge electrodes 470 are disposed in the barrier rib structure 414. The first discharge electrodes 460 and the second discharge electrodes 470 are formed in pairs to generate discharge in the discharge cells 430. The first discharge electrodes 460 and the second discharge electrodes 470 extend in a first direction (e.g., a Y direction) in a stripe shape and are disposed to face each other with respect to the center of the discharge cell 430. Uniform discharge is generated in the discharge cells 430 since the first discharge electrodes 460 and the second discharge electrodes 470 have a facing discharge structure.

The address electrodes 480 that extend in a second direction (e.g., an X direction) crossing the first direction of the first discharge electrodes 460 and the second discharge electrodes 470 are formed in the sealing layer 420. In the present embodiment, damage to the address electrodes 480 is reduced (or prevented) since the address electrodes 480 are disposed in the sealing layer 420 formed of a dielectric material. In one embodiment, the first discharge electrodes 460 act as scanning electrodes and the second discharge electrodes 470 act as common electrodes, but the present invention is not limited to such an arrangement.

Since the first and second discharge electrodes 460 and 470 are buried in the barrier rib structure 414, the barrier rib structure 414 may be formed of a dielectric material that can reduce (or prevent) a direct electrical connection between the adjacent first and second discharge electrodes 460 and 470, can reduce (or prevent) the first and second discharge electrodes 460 and 470 from being damaged due to direct collisions with positive ions or electrons, and can accumulate wall charges by inducing charges.

The protective layer(s) 415 are formed on sidewalls and upper surfaces of the barrier rib structure 414 and on the sealing layer 420 exposed by the discharge cells 430. The protective layer(s) 415 can be formed by depositing MgO to a thickness (that may be predetermined) on the sidewalls and the upper surfaces of the barrier rib structure 414.

A plurality of first grooves 410a having a depth (that may be predetermined) are formed in the substrate 410 facing each of the discharge cells 430. The first grooves 410a are discontinuously formed in each of the discharge cells 430, and the phosphor layers 425 are disposed in the first grooves 410a. A description of the phosphor layers 425 is substantially identical to the description of the phosphor layers 225 in FIGS. 2 through 5, and thus, a description thereof will not be repeated.

A discharge gas such as an Ne gas, an Xe gas or a mixed gas of Ne gas and Xe gas is filled into the discharge cells 430.

A method of manufacturing the PDP 400 according to an embodiment of the present invention is substantially identical to the method of manufacturing the PDP 200 as described above, and thus, a description thereof will not be repeated.

A method of driving the PDP 400 having the above structure according to the present embodiment will now be described.

First, address discharge is generated between the first and second discharge electrodes 460 and 470, and as a result, discharge cells 430 where sustain discharge will be generated are selected. Afterwards, when an alternating current sustain voltage is applied between the first and second discharge electrodes 460 and 470 in the selected discharge cells 430, sustain discharge is generated between the first and second discharge electrodes 460 and 470. Ultraviolet rays are generated from the discharge gas excited by the sustain discharge while an energy level of the discharge gas is reduced. The ultraviolet rays excite the phosphor layers 425, and the excited phosphor layers 425 emit visible light while an energy level of the phosphor layers 425 is reduced. The emitted visible light forms an image.

### Third Embodiment

FIG. 10 is a cross-sectional view illustrating a plasma display apparatus 1000 according to another embodiment of the present invention. The plasma display apparatus 1000 includes the PDP 200 of FIGS. 2 through 5 and a chassis 500 disposed on a rear of the sealing layer 220 of the PDP 200. The chassis 500 dissipates heat transmitted from the PDP 200 and structurally supports the PDP 200. A driving unit for driving the PDP 200 can be disposed on a side of the chassis 500.

In FIG. 10, the PDP 200 is depicted as an example of a PDP, but the present invention is not limited thereto. That is, any suitable type of PDP, including the PDP 400, can be applied to the plasma display apparatus 1000 of FIG. 10.

Referring to FIG. 10, the plasma display apparatus 1000 does not require an additional rear substrate, unlike a conventional plasma display apparatus. Accordingly, an overall weight and manufacturing cost of the PDP 200 are reduced. Also, a manufacturing method is simplified.

In FIG. 10, the PDP 200 is shown to directly contact the chassis 500, but the present invention is not limited to such an arrangement. That is, a thermal conductive sheet can be interposed between the sealing layer 220 and the chassis 500 in order to diffuse heat generated by the PDP 200 and/or to transmit the heat to the chassis 500. Also, in order to increase a mechanical combining force between the PDP 200 and the chassis 500, an adhesive member such as a double sided tape can be interposed between the chassis 500 and the sealing layer 220.

In view of the foregoing, a structure wherein discharge electrodes are disposed inside the barrier rib structure has been described as a representative embodiment of the present invention. However, the present invention can also be applied in a conventional three-electrode surface discharge type PDP.

In addition, since a PDP according to an embodiment of the present invention does not require an additional rear substrate, the weight of the PDP is reduced and the manufacturing cost of the PDP is reduced.

Moreover, in one embodiment of the present invention, since a barrier rib structure of a PDP and a sealing layer can be formed as one unit, an overall manufacturing process is simplified.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display panel comprising:
a substrate;
a barrier rib structure disposed on the substrate to define a plurality of discharge cells;
a sealing layer configured together with the substrate to seal the discharge cells and being formed of a substantially identical material as the barrier rib structure;
a plurality of discharge electrode pairs extending along respective lines of the discharge cells to generate discharge in the discharge cells; and
a plurality of phosphor layers disposed in the discharge cells.

2. The plasma display panel of claim 1, wherein the sealing layer and the barrier rib structure are formed of a dielectric material.

3. The plasma display panel of claim 2, wherein the sealing layer and the barrier rib structure comprise at least one material selected from the group consisting of SiO₂, Al₂O₃, TiO₂, BaO, CaO, B₂O₃, ZnO, R₂O PbO, Bi₂O₃, Ca—B—SiO₂, SnO, and combinations thereof.

4. The plasma display panel of claim 1, wherein the sealing layer and the barrier rib structure are formed as one unit.

5. The plasma display panel of claim 1, wherein the discharge electrode pairs are disposed in the barrier rib structure.

6. The plasma display panel of claim 1, wherein each of the discharge electrode pairs comprises a first discharge electrode extending along a first direction and a second discharge electrode extending along a second direction to cross the first direction.

7. The plasma display panel of claim 6, wherein the first and second discharge electrodes extend to surround the discharge cells disposed along respective lines of the discharge cells.

8. The plasma display panel of claim 1, further comprising a plurality of address electrodes crossing the discharge electrode pairs, wherein each of the discharge electrode pairs comprises a first discharge electrode and a second discharge electrode disposed in parallel with each other.

9. The plasma display panel of claim 8, wherein the first discharge electrode and the second discharge electrode are disposed to face each other with respect to a center of the discharge cells.

10. The plasma display panel of claim 8, wherein the first and second discharge electrodes extend to surround the discharge cells disposed along a line of the discharge cells.

11. The plasma display panel of claim 8, wherein the address electrodes are buried in the sealing layer.

12. The plasma display panel of claim 1, wherein a plurality of grooves having a depth are formed in the substrate facing the discharge cells, and the phosphor layers are formed in the grooves.

13. A plasma display apparatus comprising:
a substrate;
a barrier rib structure disposed on the substrate to define a plurality of discharge cells;
a sealing layer configured together with the substrate to seal the discharge cells and being formed of substantially identical material as the barrier rib structure;
a plurality of discharge electrode pairs extending along respective lines of the discharge cells to generate discharge in the discharge cells;
a plurality of phosphor layers disposed in the discharge cells; and
a chassis disposed on a side of the sealing layer to support the substrate.

14. The plasma display apparatus of claim 13, wherein the sealing layer and the barrier rib structure are formed of a dielectric material.

15. The plasma display apparatus of claim 14, wherein the sealing layer and the barrier rib structure comprise at least one material selected from the group consisting of SiO₂, Al₂O₃, TiO₂, BaO, CaO, B₂O₃, ZnO, R₂O PbO, Bi₂O₃, Ca—B—SiO₂, SnO, and combinations thereof.

16. The plasma display apparatus of claim 13, wherein the sealing layer and the barrier rib structure are formed as one unit.

17. The plasma display apparatus of claim 13, wherein the discharge electrode pairs are disposed in the barrier rib structure.

18. The plasma display apparatus of claim 13, wherein each of the discharge electrode pairs comprises a first discharge electrode extending along a first direction and a second discharge electrode extending along a second direction to cross the first direction.

19. The plasma display apparatus of claim 13, wherein the address electrodes are buried in the sealing layer.

20. The plasma display apparatus of claim 13, wherein a plurality of grooves having a depth are formed in the substrate facing the discharge cells, and the phosphor layers are formed in the grooves.
